(19) United States
(12) Patent Application Publication
(10) Pub. No.: US 2024/0066467 A1
(43) Pub. Date: Feb. 29, 2024

(54) CATALYTIC DIHYDROGEN RECOMBINER

(71) Applicant: SOLETANCHE FREYSSINET, RUEIL-MALMAISON (FR)

(72) Inventor: Philippe CHANTEREAU, SETE (FR)

(21) Appl. No.: 18/271,234

(22) PCT Filed: Jan. 6, 2022
(86) PCT No.: PCT/EP2022/050209

§ 371 Date: Jul. 6, 2023

(30) Foreign Application Priority Data
Jan. 7, 2021 (FR) FR2100138

(51) Int. Cl. B01D 53/86; B01J 35/04

(52) U.S. Cl. CPC B01D 53/8671; B01J 35/04; B01D 2255/1021; B01D 2255/1023; B01D 2255/1025; B01D 2257/108

(57) ABSTRACT

Catalytic dihydrogen recombiner (1), comprising: —at least a first catalytic block (30a) of a honeycomb substrate made of a material with low thermal conductivity, having a first catalytic coating, —at least a second catalytic block (30b) of a honeycomb substrate made of a material with low thermal conductivity, having a second catalytic coating, said second substrate having the same cross-section as the first, —a structure (3, 21) for supporting the blocks one on top of the other and/or one next to the other.

### TECHNICAL FIELD

The present invention concerns catalytic dihydrogen recombiners, also known as catalytic recombiners.

### PRIOR ART

The presence of gaseous dihydrogen is dangerous in certain situations (nuclear containment shells, batteries, fuel cells, hydrogen production, storage, transport or distribution of hydrogen, electrolytic water treatment etc.), and catalytic recombiners have been proposed for reducing the dihydrogen concentration by provoking its recombination with the surrounding oxygen.

Most known catalytic recombiners comprise metal plates covered with catalytic material and arranged parallel with one another in a support frame.

Such recombiners have drawbacks.

Firstly, the reactive surface area is relatively small in relation to the volume occupied, which makes them bulky and impractical to install. This drawback is significant when the object is to equip pre-existing nuclear installations for which safety improvements are required by the authorities and operators, since it becomes difficult to install recombiners in the locations most relevant for potential accumulation of dihydrogen pockets if these locations are already packed with equipment.

Finally, the plates are liable to deform in the case of seismic activity, which can modify the characteristics of gaseous flow between the plates and make them less effective.

Finally, such recombiners do not allow easy modification of the composition of the catalytic material in order to better adapt to the environment in which the recombiner is used.

Application FR2999442 describes a device comprising a honeycomb catalyst for passive recombination of dihydrogen. The honeycomb structure is self-supporting, being formed by an embossed metal strip wrapped onto itself, this strip being covered with a catalytic material, for example platinum and palladium on aluminum. In one example, two honeycomb catalysts are used, the first being arranged in a conduit of large cross-section, formed by a catalyst support frame, the second in a path of smaller cross-section on top of the first. In another example, the two catalysts are arranged concentrically on metal supports and have different compositions in terms of catalytic materials. A heating means may be integrated into the frame carrying the catalysts.

Patent KR101312857B1 describes a passive recombiner comprising a ceramic honeycomb support coated with a catalytic material and arranged in a rack which is movable relative to a support frame. The presence of the rack allows easy extraction of the ceramic support for operations of inspection or maintenance.

Application JP H02 1377 03 discloses a catalytic recombiner comprising several stacked blocks and comprising a honeycomb substrate, the cells of which may vary in size from one block to the next.

### PRESENTATION OF THE INVENTION

There is a need to perfect catalytic dihydrogen recombiners further, in particular in order to improve their performance and facilitate their adaptation to a given environment.

The invention applies to both passive and active recombiners.

The term “passive” means that no exterior action is required to achieve the recombination of dihydrogen, and the gaseous mixture is introduced without the supply of external energy, the flow being obtained by natural convection, in particular under the effect of an inlet-outlet temperature gradient. In an “active” recombiner, an exterior action is performed to force the gaseous flow at the inlet, for example the presence of a fan or turbine.

### SUMMARY OF THE INVENTION

The invention aims to achieve the above-mentioned object and does so with a catalytic dihydrogen recombiner, comprising:
at least one first catalytic block of an alveolar substrate, preferably made of a material with low thermal conductivity, in particular a ceramic, and having a first catalytic coating,
at least one second catalytic block of an alveolar substrate, preferably made of a material with low thermal conductivity, in particular a ceramic, and having a second catalytic coating, said second block advantageously having the same cross-section as the first,
a structure for supporting the blocks one above the other and/or one next to the other.

A “material with low thermal conductivity” means a material with a thermal conductivity of less than or equal to 20 Wm⁻¹K⁻¹ at 20° C., preferably less than or equal to 10 Wm⁻¹K⁻¹, more preferably less than or equal to 7.5 Wm⁻¹K⁻¹, for example between 0.5 and 7.5 Wm⁻¹K⁻¹.

The substrate gives the block its mechanical integrity and internal cohesion. For the first and/or second block, the corresponding catalytic coating may be present at least on the internal surface of cells, or exclusively thereon. When the catalytic coating is present only on the internal surface of the cells, the lateral exterior surface of the block has no catalytic coating. This may avoid exposing the material of a block support rack directly to the reaction occurring at the catalytic material.

The support structure may have a body defining a conduit inside which the blocks are placed.

The invention has multiple advantages.

Firstly, the alveolar structure of the blocks allows a high specific density of the catalyst thanks to a large exchange area per volume unit.

The catalytic coating, which is preferably situated inside the block on the surface of the cells, is therefore protected from any risk of damage during handling or unintended contact with the block.

The fact that the blocks have the same cross-section gives the assembly a modular aspect, which facilitates the interchangeability of catalytic blocks as a function for example of the nature of the catalyst or catalysts present, so as to best adapt the recombiner to the usage conditions and optimize its performance, for example for recombining as much or as little dihydrogen as possible at the inlet, depending on the desired trigger temperature.

In particular, the arrangement of the blocks may be designed to achieve a lower trigger temperature at the inlet. The interchangeability of the blocks means they can be arranged in one sequence or another in order to achieve a higher or lower trigger temperature.

Furthermore, a stock of catalytic blocks of different properties may easily be maintained, for the use of different catalysts and/or for usage in different quantities, and from the stock produce the combinations most suited to a specific environment.

The modular character may also allow, in some cases, use of a smaller or larger number of catalytic blocks within the recombiner, and catalytic blocks of greater or lesser thickness. The invention allows simple intervention for replacement of a single block, and facilitates the modularity/adaptability of the recombiner in the case of a larger release of dihydrogen in the volume to be protected. For example, it is sufficient to increase the frontal surface area exposed to the flow in order to allow a greater quantity of dihydrogen to enter the recombiner while having a single model of catalytic block.

Preferably, the support structure holds the blocks one above the other.

Preferably, the substrate has refractory properties, which allows use of the recombiner in a high-temperature atmosphere during normal operation (i.e. before triggering of the catalytic reaction corresponding to the arrival of dihydrogen).

Another benefit of the refractory nature is that it is possible to consider the use of organic materials (for example, technical plastic materials), for which the usage temperature is more limited than that of metal, to create the structure of the recombiner frame.

Finally, the rigidity of the substrate reduces the risk of modification of the cross-section of the flow channels in the case of seismic activity, in comparison with conventional plate recombiners.

Preferably, the support structure comprises racks supporting the catalytic blocks and arranged to allow individual extraction of each rack independently of the other rack or racks. Each rack for example has a lower frame on which the blocks are placed, this frame being extended upward by at least two mutually opposite uprights, between which the blocks are received. At least one fixing plate may be connected to the frame to allow the rack to be fixed to the body of the recombiner. Preferably, this plate has vertical oblong holes allowing adjustment of the vertical position of the rack within the body of the recombiner. The support structure may also comprise an upper frame which is fixed in the body of the recombiner above the blocks and holds them resting against the lower frame. This upper frame may be integral with a fixing plate on the body of the recombiner. This plate may have vertical oblong holes allowing height adjustment of the upper frame in the body of the recombiner.

At least one passage for a rising gaseous flow may be arranged between the blocks and the body of the recombiner, in particular a rising gaseous flow which is passively generated so as to create a suction through the blocks by Venturi effect. In this way, a gaseous circulation may be encouraged which is designed to facilitate the triggering of the reaction, for example. The Venturi effect is also particularly useful for so-called “active” operating conditions, i.e. with a forced flow to be treated, generated for example by a fan or turbine, since the flow speed in this case is higher and adjustable.

In an exemplary implementation of the invention, inside the body, at least two racks are attached to each of the two opposite faces of the body of the recombiner, providing a gap between the racks, both between those fixed to a same face and between those on opposite faces. For example, four racks are provided which substantially take up the entire inner cross-section of the body, while leaving a space between them and between the racks and the faces of the body other than the two faces on which the racks are fixed.

Each substrate preferably has a structure with parallel channels, and various channel cross-sections are possible, for example hexagonal cross-sections or of another shape, for example circular or polygonal but not hexagonal, e.g. square.

The general form of the blocks may be variable, for example square, rectangular, cylindrical or other viewed from the front, so as to adapt to different environmental and/or flow conditions.

The various blocks may be obtained by extrusion or casting in a die with the same cross-section but with thicknesses which may vary, in some cases, from one block to another. Within the recombiner, the various successive catalytic blocks arranged at different heights may have the same thickness or different thicknesses.

As a non-limitative example, the first and second catalytic coatings may differ at least in the nature of the catalyst. Thus an inlet catalytic block may be used which comprises a catalyst allowing triggering of the reaction at a lower temperature, and at least one catalytic block arranged above this which comprises a catalyst requiring a higher temperature in order to react. The first and second coatings may differ at least in the quantity of catalyst, and/or in the nature of the catalyst.

The first and second blocks may have different thicknesses, as stated above. A thinner block may then comprise a smaller quantity of catalyst for example.

The recombiner may comprise a heating element situated close to at least one of the blocks. For example, the recombiner comprises at least one resistive heating track arranged on at least one of the substrates. This may for example allow the trigger temperature necessary for the function of the recombiner to be reached more easily or quickly. This resistive track is for example deposited by printing an electrically conductive ink.

The recombiner may comprise at least one temperature sensor for measuring the temperature close to at least one of the blocks.

The recombiner may comprise a greater or lesser number of catalytic blocks, and for example at least three catalytic blocks arranged one above the other, each of different nature, composition and/or geometry, wherein the number of catalytic blocks and the diversity of their characteristics within the same recombiner are not limited.

The support structure may be configured to be suspended within the enclosure to be protected, and to this end may comprise suspension elements in the upper part. These suspension elements may in some cases be height-adjustable, e.g. telescopic. As a variant, the support structure is configured to be fixed via an arm to a side wall of the enclosure to be equipped.

The support structure may comprise a hopper in the lower part, e.g. with cross-section between 0.1 and 1 m2. The inlet cross-section may be rectangular in form, for example with one side of dimensions between 0.2 and 0.4 m, and the other between 0.4 and 0.6 m (these dimensions are merely an example and are in no way limitative).

The support structure may have a vertical conduit forming a chimney, the catalytic blocks being arranged above the hopper and at the inlet of the conduit forming the chimney. The latter may be held by said suspension elements.

The “monolithic” geometry of the substrate, which is associated with the nature of the material (preferably both rigid and lightweight), has the advantage that thinner blocks may be produced with larger dimensions (e.g. 1 m×1 m, and with a thickness of 1 to 20 times less, ranging from 5 to 10 cm for example).

This flexibility in production of the blocks means that applications can be considered in which the blocks are produced as panels in order to cover the walls of large-volume enclosures (e.g. reactor containment shells etc.) which are exposed to dihydrogen release.

A further object of the invention, independently or in combination with the above, is a monolithic panel catalytic dihydrogen recombiner, in particular produced with an alveolar structure of low thermal conductivity, preferably of ceramic, characterized in that it has a thickness which is 1 to 20 times smaller than its largest dimension, preferably 5 to 20 times smaller, more preferably 10 to 20 times smaller, wherein the largest dimension is for example greater than or equal to 0.5 m, preferably 0.75 m, more preferably 1 m. The panel may take the form of a generally square or rectangular slab with a long side measuring for example more than 0.5 m, more preferably 0.75 m, more preferably 1 m or more. The thickness of such a panel is preferably at least five, and preferably at least ten times smaller than the size of the slab, the thickness being preferably between 5 and 10 cm.

A further object of the invention is an enclosure, in particular for a reactor, the wall of which is at least partially clad in such panels.

### BRIEF DESCRIPTION OF THE DRAWINGS

The invention will be better understood from reading the detailed description below of non-limitative exemplary embodiments thereof, and from examination of the attached drawing in which:

FIG. 1 illustrates schematically in perspective an example of a catalytic recombiner according to the invention,

FIG. 2 illustrates the function of the recombiner,

FIG. 3 shows in isolation, schematically and partially, an example of the means for supporting the catalytic blocks inside the body of the recombiner,

FIG. 4 shows in isolation and in perspective an example of a catalytic block,

FIG. 5 shows the block from FIG. 4 in a front view,

FIG. 6 shows in isolation the rack of the support means of FIG. 3,

FIG. 7 is an exploded, schematic and partial view of a variant of a recombiner,

FIG. 8 is a schematic perspective view of a variant of a recombiner in which the means of support of the catalytic blocks are shown transparently,

FIG. 9 is a cross-section of the recombiner from FIG. 8,

FIG. 10 illustrates the removal of the block support means,

FIG. 11 shows partially and schematically an example of a resistive track present on the substrate of a catalytic block, and

FIG. 12 shows schematically and partially a temperature sensor mounted close to a catalytic block.

### DETAILED DESCRIPTION

On the figures, with the aim of clarity, the various constituent elements of the recombiner are not always shown to scale and with observation of relative proportions.

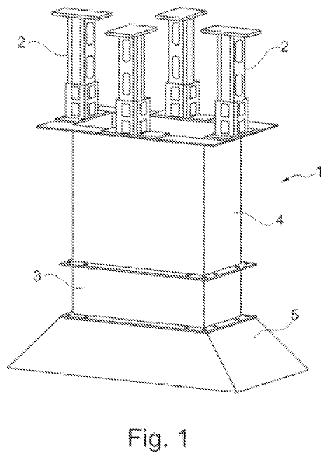

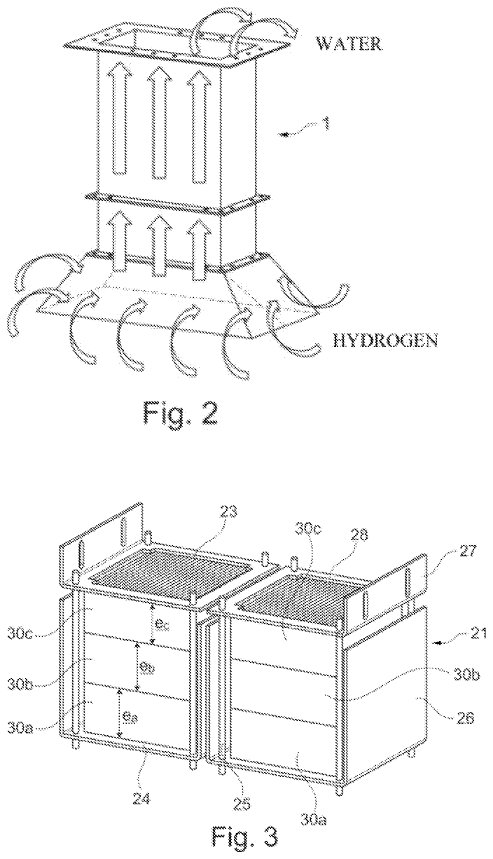

FIGS. 1 and 2 show a first example of a recombiner 1 according to the invention.

This recombiner 1 comprises a support structure for catalytic blocks which may be designed to be suspended within the enclosure to be protected, and to this end may comprise in the upper part a set of suspension elements 2, as illustrated. These suspension elements 2 are for example height-adjustable.

In the variants (not shown), the recombiner 1 is designed for wall mounting, to be suspended from an arm bracket, or to be placed on the ground.

In the example illustrated, the recombiner 1 comprises a body 3 housing the catalytic blocks as described below, over which is a conduit 4 forming a chimney and connected to the suspension elements 2 at the upper end.

The body 3 may at the lower end be connected to a hopper 5 as illustrated, which is open towards the bottom.

In operation, hydrogen is drawn in passively through the hopper 5 and a catalytic combustion occurs with the oxygen in the air, producing water vapor which leaves through the upper end of the conduit 4 as illustrated. The arrows on FIG. 2 shows the preferred flow direction resulting from natural circulation, provoked by the temperature gradient due to the exothermic nature of the catalytic reaction.

The catalytic blocks may be supported within the recombiner in various ways.

In the example of FIG. 3, the body 3 houses two racks 21 for supporting the blocks.

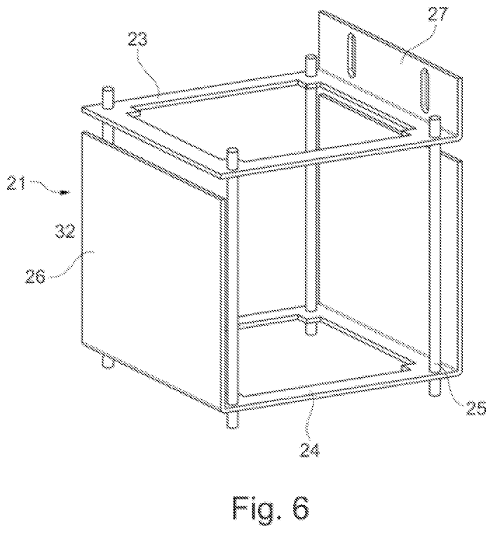

Each rack 21 comprises top and bottom grilles 23 (the bottom grille not being visible on FIG. 3) supported by respective frames 24 and 28 which are connected together by vertical columns 25, as shown in particular on FIG. 6. Three catalytic blocks 30a, 30b, 30c are for example arranged between the grilles 23 and 24 of each rack 21, as illustrated in FIG. 3.

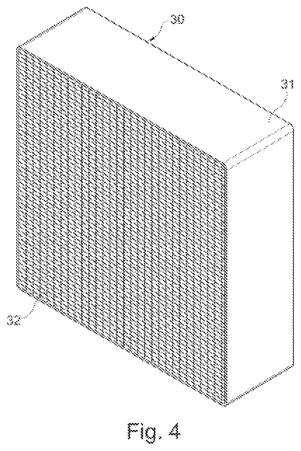

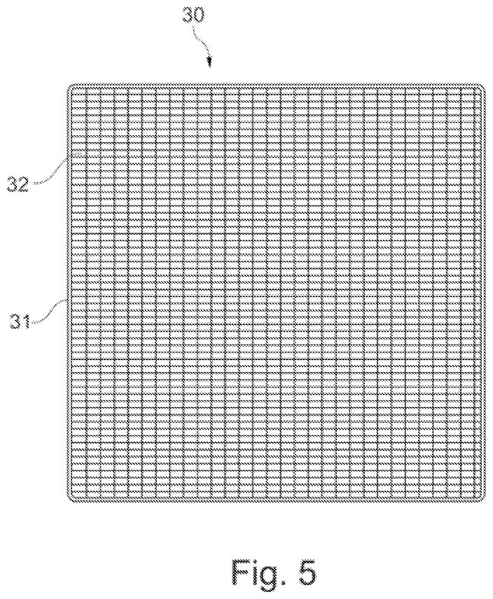

An exemplary catalytic block 30 is illustrated in isolation in FIGS. 4 and 5.

The latter comprises a ceramic substrate 31 through which pass a plurality of parallel channels 32 (also called cells), for example each of square cross-section as illustrated.

All blocks 30a, 30b and 30c may be produced by extrusion from a same ceramic substrate, for example of cordierite (thermal conductivity of the order of 3 Wm⁻¹K⁻¹ at 25° C.), and thus have the same cross-section.

The substrate 31 of the blocks is coated with a catalyst, for example one or more metals such as Pt, Pd, Rh etc., at the level of the channels 32.

Each rack 21 may comprise uprights 26 which extend over at least part of the height of the blocks 30. These uprights 26 are for example made integrally with the metal of the support frame 24 of the lower grille, as shown in FIG. 5.

The support frame of the upper grille 23 may be connected at one edge to a fixing plate 27 allowing the rack 21 to be attached to the body 3, for example using screws (not shown).

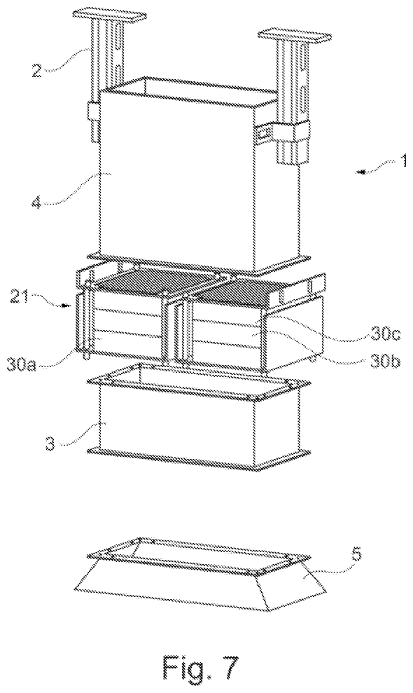

In the variant illustrated in FIG. 7, the suspension elements 2 are designed to be fixed to the side of the conduit 4, for example on two opposite sides as illustrated, and not at the upper end.

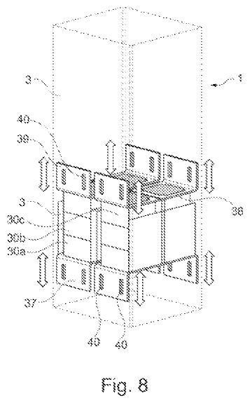

In the variant illustrated on FIGS. 8 to 10, the recombiner 1 comprises a body 3 forming a conduit, which for example accommodates four support racks 21 arranged in the cross-section as two rows of two.

Each rack 21 for example comprises a lower frame 24 for supporting the blocks and two mutually opposite uprights 26 extending the frame 24 upward, and between which the blocks 30a, 30b, 30c are accommodated. The height of the uprights 26 in this example is less than the cumulative height of the three blocks, such that the upper block 30c is only partially accommodated between the uprights 26.

The frame 24 is connected to a fixing plate 37 which extends downward.

This plate 37 has vertical oblong holes 40 which allow adjustment of the height of the rack 21 in the body 3, as illustrated by the arrows in FIG. 8.

The frames 38 held by the plates 39 are fixed above the racks 21 so as to hold the blocks in place between the uprights 26 against vertical vibrations, for example. These plates 39 have vertical oblong holes 40 like the plates 37, allowing adjustment of their position in the body 3, so that the blocks can be axially wedged between the frames 24 and 38. The latter may carry grilles in some cases.

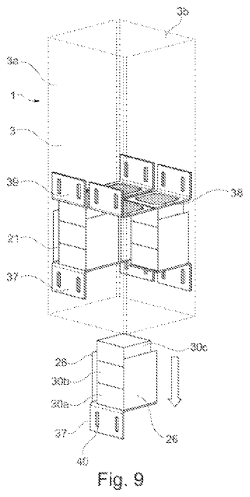

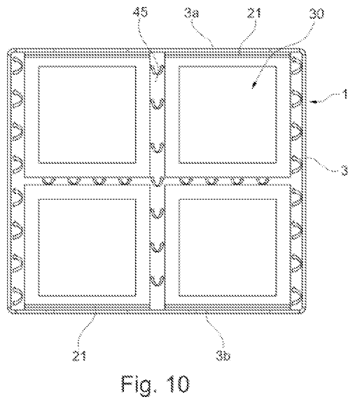

The plates 37 and 39 serving to hold a same assembly of catalytic blocks are fixed to a same face 3a or 3b of the body 3, as shown on FIG. 9 in particular.

The dimensions of the blocks and racks 21 may be selected such that passages remain on the three free sides of each rack 21, outside the blocks, as illustrated on FIG. 9. This way of holding the blocks 30a, 30b, 30c within the recombiner allows both gaseous circulation through the blocks and circulation outside the blocks, around these, inside the body 3. Such a circulation may promote the creation of an air suction through the blocks via the Venturi effect, known as false injection, and improve the triggering of the catalytic reaction for example.

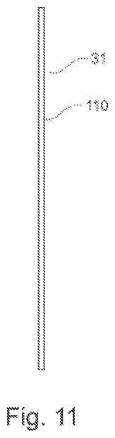

Each rack 21 may be extracted independently of the other three, as illustrated in FIG. 10, by removing the screws which hold the lower plate 37 to the body 3.

In all the examples described with reference to the figures, the catalytic blocks advantageously have different catalytic properties: for example, the inlet catalytic block 30a at the bottom has a catalyst allowing triggering of the reaction of oxygen with hydrogen at a lower temperature than the catalysts of the other blocks. The heat released during oxidation heats the blocks 30b and 30c situated above, which allows these blocks to have catalysts which require a higher trigger temperature but are for example less costly.

The size and shape of the cells of the catalytic blocks is adapted to the desired objective, in particular in terms of loss of hydraulic load, flow speed, presence of any instrumentation etc. In the example illustrated, the respective thicknesses eₐ, e_{b}, e_{c} of the blocks 30a, 30b, 30c are equal, but blocks of different thicknesses may be used, wherein blocks with thicknesses which are the example half the size of those of another block may be arranged within a same compartment.

Any suitable material, in particular ceramic, may be used for production of the substrate of the blocks.

A catalyst with a given formulation may be arranged partially or fully over the inner surfaces of the cells of the substrate.

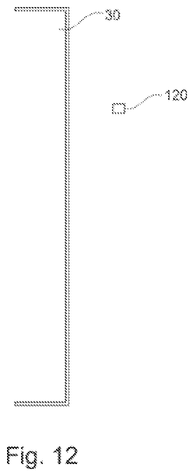

Each block or block support may be equipped with dedicated instrumentation and/or a specific heating system, intended for example to accelerate triggering of the catalytic reaction at a given H₂ concentration. For example, FIG. 12 shows the positioning of a temperature sensor 120 close to a block 30.

For heating of a block, advantageously tracks of an electrical conductor 110 may be printed onto the substrate 31 of the block in order to produce a heating resistance, as illustrated highly schematically in FIG. 11. As a variant, a heating resistance is for example pressed against the inlet face of the lower catalytic block.

In variants not shown, the recombiner 1 is produced with a conduit forming a chimney of different height, or without such conduit.

The hopper 5 may be produced with a different geometry and opening angle, and the recombiner may be produced without such a hopper in some cases.

The catalytic block 30 may be held differently without leaving the scope of the present invention.

The recombiner may have a totally passive nature requiring no energy supply from an energy source, for example electrical, in order to begin functioning.

In variants not shown, with the aim of improving the flow rate compatible with the catalytic recombination rate permitted by the high density of the catalyst linked to the arrangement of alveolar cells, the recombiner is associated with an actuator such as an extractor (ventilator, fan etc.) at the level of the conduit 4 forming the chimney for example.

1. A catalytic dihydrogen recombiner, comprising:
at least one first catalytic block of an alveolar substrate, made of a material with low thermal conductivity, having a first catalytic coating,
at least one second catalytic block of an alveolar substrate, made of a material with low thermal conductivity, having a second catalytic coating, said second substrate having the same cross-section as the first,
a structure for supporting the blocks one above the other and/or one next to the other.

2. The recombiner as claimed in claim 1, wherein the support structure holds the blocks one above the other.

3. The recombiner as claimed in claim 1, wherein the support structure comprises racks supporting the blocks and arranged to allow individual extraction of each rack independently of the other rack or racks.

4. The recombiner as claimed in claim 1, wherein the support structure comprises a body defining a conduit, at least one passage for a rising gaseous flow being arranged between the catalytic blocks and said body (3).

5. The recombiner as claimed in claim 1, wherein each substrate has a structure with parallel channels.

6. The recombiner as claimed in claim 1, wherein the first and second catalytic coatings differ at least in the nature of the catalyst.

7. The recombiner as claimed in claim 1, wherein the first and second catalytic coatings differ at least in the quantity of catalyst.

8. The recombiner as claimed in claim 1, wherein the first and second catalytic blocks have different thicknesses.

9. The recombiner as claimed in claim 1, wherein the first and second catalytic blocks have a same thickness.

10. The recombiner as claimed in claim 1, comprising a heating element situated close to at least one of the blocks.

11. The recombiner as claimed in claim 1, comprising at least one resistive heating track arranged on at least one of the substrates.

12. The recombiner as claimed in claim 1, comprising at least one temperature sensor for measuring the temperature close to at least one of the blocks.

13. The recombiner as claimed in claim 1, comprising at least three blocks of a ceramic alveolar substrate having a catalytic coating, arranged one above the other.

14. A monolithic panel catalytic dihydrogen recombiner, produced with an alveolar structure of low thermal conductivity having a thickness which is 1 to 20 times smaller than its largest dimension.

15. The recombiner as claimed in claim 4, the at least one passage for rising gaseous flow which is passively generated so as to create a suction through the blocks by Venturi effect.

16. The panel of claim 14, wherein the largest the largest dimension is greater than or equal to 0.5 m.

17. The panel of claim 16, wherein the panel takes the form of a generally square or rectangular slab with a long side measuring more than 0.5 m, the thickness of such a panel being at least five times smaller than the size of the slab, the thickness being between 5 and 10 cm.
